(19) United States
(12) Patent Application Publication
(10) Pub. No.: US 2018/0290922 A1
(43) Pub. Date: Oct. 11, 2018

(54) Amino Acid-Containing Sizing Compositions For Glass Fibers And Sized Fiber Glass Products

(71) Applicant: PPG INDUSTRIES OHIO, INC., Cleveland, OH (US)

(72) Inventor: Nilmini ABAYASINGHE, Spartanburg, SC (US)

(21) Appl. No.: 15/522,144

(22) PCT Filed: Oct. 30, 2015
(86) PCT No.: PCT/US2015/058187

§ 371 Date: Apr. 26, 2017

Related U.S. Application Data
(60) Provisional application No. 62/072,591, filed on Oct. 30, 2014.

(51) Int. Cl. C03C 25/25; C03C 13/00; C04B 14/42; C04B 20/10; C08J 5/08; C03C 25/32; C03C 25/321; C03C 25/36; C03C 25/1025

(52) U.S. Cl. CPC C03C 25/25; C03C 13/00; C04B 14/42; C04B 20/104; C04B 2111/00612; C03C 25/32; C03C 25/321; C03C 25/36; C03C 25/103; C08J 5/08

(57) ABSTRACT

The present invention relates to amino acid-containing sizing compositions for glass fibers, to glass fibers at least partially coated with such sizing compositions, to a variety of fiber glass products at least partially coated with such sizing compositions, and to composite materials comprising glass fibers at least partially coated with such sizing compositions. In one non-limiting embodiments, a sizing composition for glass fibers comprises an amino acid, a protein, or a hydrolyzed protein. A sizing composition for glass fibers, in another non-limiting embodiment, comprises an amino acid, a protein, or a hydrolyzed protein, at least one film-former, and at least one silane.

### CROSS REFERENCE TO PRIORITY APPLICATION

This application claims priority to U.S. Provisional Application No. 62/072,591, filed Oct. 30, 2014, which is incorporated herein by reference in its entirety.

### FIELD OF THE INVENTION

The present invention generally relates to amino acid-containing sizing compositions for glass fibers, to fiber glass strands comprising at least one glass fiber at least partially coated with an amino acid-containing sizing composition, and to related products.

### BACKGROUND OF THE INVENTION

Various chemical treatments exist for glass-type surfaces such as glass fibers to aid in their processability and applications. Before bundling the filaments together after formation, a coating composition or sizing composition is applied to at least a portion of the surface of the individual filaments to protect them from abrasion and to assist in processing. As used herein, the terms “sizing composition,” “sizing,” “binder composition,” “binder,” or “size” refer to a coating composition applied to the filaments immediately after forming. Sizing compositions can provide protection through subsequent processing steps, such as those where the fibers pass by contact points as in the winding of the fibers and strands onto a forming package, drying the aqueous-based or solvent-based sizing composition to remove the water or solvent, twisting from one package to a bobbin, beaming to place the yarn onto very large packages ordinarily used as the warp in a fabric, chopping in a wet or dry condition, roving into larger bundles or groups of strands, unwinding for use as a reinforcement, weaving, and other downstream processes.

In addition, sizing compositions can play a dual role when placed on fibers that reinforce polymeric matrices in the production of fiber-reinforced plastics or in the reinforcement of other materials. In the reinforcement of polymeric matrices, the sizing composition can provide protection and also can provide compatibility between the fiber and the matrix polymer or resin. For example, glass fibers in the forms of both woven and nonwoven fabrics and mats and rovings and chopped strands have been used with resins, such as thermosetting and thermoplastic resins, for impregnation by, encapsulation by, or reinforcement of the resin. In such applications, it may be desirable to maximize the compatibility between the surface and the polymeric resin while also improving the ease of processability and manufacturability.

### SUMMARY

The present invention relates generally to amino acid-containing sizing compositions for glass fibers, glass fibers, fiber glass strands, composite materials comprising glass fibers, and cement boards reinforced with fiber glass strands. In some embodiments, a sizing composition for glass fibers comprises an amino acid, a protein, a hydrolyzed protein, or combinations thereof.

In one embodiment of the present invention, a sizing composition comprises an amino acid, a protein, or a hydrolyzed protein from a plant source. As used herein, “an amino acid,” “a protein,” and “a hydrolyzed protein” include one or more amino acids, one or more proteins, and one or more hydrolyzed proteins, respectively. In embodiments comprising a protein, the protein, in some embodiments, can comprise a plant-based protein. In some embodiments comprising an amino acid, the amino acid can be derived from a plant-based protein. In some embodiments comprising a hydrolyzed protein, the hydrolyzed protein can comprise a hydrolyzed plant-based protein. The plant-based protein, in some embodiments, comprises at least one of amaranth, soy protein, wheat protein, corn protein, rice protein, vegetable protein, and mixtures thereof.

In some embodiments, the sizing composition comprises an amino acid, a protein, or a hydrolyzed protein from an animal source. In those embodiments comprising a protein, the protein, in some such embodiments, can comprise an animal-based protein. In some embodiments comprising an amino acid, the amino acid can be derived from an animal-based protein. In some embodiments comprising a hydrolyzed protein, the hydrolyzed protein can comprise a hydrolyzed animal-based protein. The animal-based protein, in some embodiments, comprises at least one of collagen, keratin, elastin, and mixtures thereof.

In some embodiments of the present invention, the sizing composition comprises an amino acid, a protein, or a hydrolyzed protein from a marine source. In those embodiments comprising a protein, the protein, in some embodiments, can comprise a marine-based protein. In some embodiments comprising an amino acid, the amino acid can be derived from a marine-based protein. In some embodiments comprising a hydrolyzed protein, the hydrolyzed protein can comprise a hydrolyzed marine-based protein. The marine-based protein, in some embodiments, comprises at least one of collagen, elastin, and mixtures thereof.

In some embodiments wherein the sizing composition comprises a protein, the protein can comprise milk protein and/or silk protein. The protein, in some embodiments, can comprise a modified protein.

In some embodiments wherein the sizing composition comprises a protein, the protein can comprise a corn protein, a wheat protein, and a soy protein. In some embodiments wherein the sizing composition comprises a hydrolyzed protein, the hydrolyzed protein can comprise a hydrolyzed corn protein, a hydrolyzed wheat protein, and a hydrolyzed soy protein.

In some embodiments wherein the sizing composition comprises an amino acid, the sizing composition can comprise a mixture of amino acids. In some such embodiments, the mixture of amino acids is derived from a corn protein, a wheat protein, and a soy protein. In some embodiments comprising an amino acid, the amino acid can be derived from a synthetic source.

In one non-limiting embodiment, the amino acid, the protein, or the hydrolyzed protein comprises at least about 0.001 weight percent of the sizing composition on a total solids basis. In some such embodiments, the amino acid, the protein, or the hydrolyzed protein comprises at least about 0.1 weight percent of the sizing composition on a total solids basis. In other such embodiments, the amino acid, the protein, or the hydrolyzed protein comprises at least about 0.3 weight percent of the sizing composition on a total solids basis.

Non-limiting embodiments of the present invention may also comprise at least one film-former. In some embodiments, the at least one film-former comprises starch. The at least one film-former, in some embodiments, comprises an epoxy.

Non-limiting embodiments of the present invention may also comprise at least one silane. Non-limiting embodiments of the present invention may also comprise at least one lubricant. In some embodiments, the at least one lubricant comprises at least one non-ionic lubricant.

A further embodiment of a sizing composition for glass fibers of the present invention comprises an amino acid, a protein, or a hydrolyzed protein; at least one film-former; and at least one silane.

The present invention also relates to glass fibers at least partially coated with any of the sizing compositions of the present invention.

The present invention also relates to fiber glass strands comprising at least one glass fiber at least partially coated with any of the sizing compositions of the present invention.

The present invention also relates to cement boards comprising at least one fiber glass strand of the present invention.

The present invention also relates to composite materials. In one embodiment, a composite material of the present invention comprises a polymeric resin and a plurality of glass fibers at least partially coated with any of the sizing compositions of the present invention disposed in the polymeric resin. The composite material, in some embodiments, comprises a pultruded product.

These and other embodiments of the present invention are described in greater detail in the Detailed Description which follows.

### DESCRIPTION OF DRAWINGS

FIG. 1 is a plot showing the yarn tensile results of a sized fiber glass strand coated with a 0% phytokeratin composition, Example 2 (1.5% phytokeratin), and Example 3 (3% phytokeratin).

FIG. 2 is a plot showing the strand tensile strengths of a sized fiber glass strand coated with a 0% phytokeratin composition, Example 2 (1.5% phytokeratin), and Example 3 (3% phytokeratin).

FIG. 3 is a plot showing the yarn tensile results of a sized fiber glass strand coated with a 0% phytokeratin composition, Example 4 (1.5% phytokeratin), and Example 5 (3% phytokeratin).

FIG. 4 is a plot showing the strand tensile results of a sized fiber glass strand coated with a 0% phytokeratin composition, Example 4 (1.5% phytokeratin), and Example 5 (3% phytokeratin).

FIG. 5 is a plot showing the short beam shear strengths of Comparative Example 1 (0% phytokeratin) and Example 6 (0.3% phytokeratin).

FIG. 6 is a plot showing the short beam shear modulus measurements of Comparative Example 1 (0% phytokeratin) and Example 6 (0.3% phytokeratin).

FIG. 7 is a plot showing the strand tensile strengths of Comparative Example 1 (0% phytokeratin) and Example 6 (0.3% phytokeratin).

FIG. 8 is a plot showing the dry roving tensile strengths of Example 7 (0.7% phytokeratin) and Example 8 (2% phytokeratin).

FIG. 9 is a plot showing the short beam shear strengths of Example 7 (0.7% phytokeratin) and Example 8 (2% phytokeratin).

### DETAILED DESCRIPTION

For the purposes of this specification, unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to any claims that might be filed in applications claiming priority to this application, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

Further, when the phrase “up to” is used in connection with an amount of a component, material, or composition in the claims, it is to be understood that the component, material, or composition is present in at least a detectable amount (e.g., its presence can be determined) and may be present up to and including the specified amount.

The present invention relates, in one aspect, to sizing compositions for fiber glass. As used herein, the term “sizing composition” refers to a coating composition applied to fiber glass filaments immediately after forming and may be used interchangeably with the terms “binder composition,” “binder,” “sizing,” and “size.” The sizing compositions described herein generally relate to aqueous sizing compositions.

A sizing composition of the present invention comprises an amino acid, a protein, and/or a hydrolyzed protein. In some embodiments, the amino acid, the protein, and the hydrolyzed protein are believed to provide film-forming and/or lubricating characteristics to the sizing composition.

In some embodiments, a sizing composition of the present invention comprises an amino acid. Amino acids useful in some embodiments of the prevent invention include proteinogenic amino acids and/or non-proteinogenic amino acids as known to those of skill in the art. As used herein, the term “proteinogenic amino acid” refers to an amino acid that can be incorporated into a protein during a protein translation process. Proteinogenic amino acids include glycine, alanine, valine, leucine, isoleucine, aspartic acid, glutamic acid, serine, threonine, glutamine, asparagine, arginine, lysine, proline, phenylalanine, tyrosine, tryptophan, cysteine, methionine, and histidine.

The term “non-proteinogenic amino acid” refers to amino acids that are not incorporated into proteins during a protein translation process and are not encoded by the standard genetic code. Non-proteinogenic amino acids include amino acid analogues, such as citrulline, cystine, homocitrulline, hydroxyproline, homoarginine, homoserine, homotyrosine, homoproline, ornithine, hydroxylysine, 4-amino-phenylalanine, sarcosine, biphenylalanine, homophenylalanine, 4-amino-phenylalanine, 4-nitro-phenylalanine, 4-fluoro-phenylalanine, 2,3,4,5,6-pentafluoro-phenylalanine, norleucine, cyclohexylalanine, α-aminoisobutyric acid, N-methyl-alanine, N-methyl-glycine, N-methyl-glutamic acid, tert-butylglycine, α-aminobutyric acid, α-aminoisobutyric acid, 2-aminoisobutyric acid, 2-aminoindane-2-carboxylic acid, selenomethionine, lanthionine, dehydroalanine, γ-amino butyric acid, naphthylalanine, aminohexanoic acid, phenylglycine, pipecolic acid, 2,3-diaminoproprionic acid, tetrahydroisoquinoline-3-carboxylic acid, tert-leucine, tert-butylalanine, cyclohexylglycine, diethylglycine, dipropylglycine and derivatives thereof.

In some embodiments, the amino acid is derived from a synthetic source. In other embodiments, the amino acid is derived from a natural source. For example, the amino acid can be derived from a plant-based protein in some embodiments. Examples of suitable plant-based proteins include amaranth, soy protein, wheat protein, corn protein, rice protein, vegetable protein, and mixtures thereof. In some embodiments, the amino acid is derived from an animal-based protein. Examples of suitable animal-based proteins include collagen, keratin, elastin, and mixtures thereof. In some embodiments, the amino acid is derived from a marine-based protein. Examples of suitable marine-based proteins include collagen, elastin, and mixtures thereof.

In some embodiments, the amino acid comprises a mixture of amino acids. The mixture of amino acids can include a proteinogenic amino acid in some embodiments. In some embodiments, the mixture of amino acids includes glutamic acid. Glutamic acid can be included in the mixture of amino acids in an amount of at least 20 weight percent of the dry amino acid mixture in some embodiments. For example, glutamic acid can be included in the mixture of amino acids in an amount of at least 23 weight percent, at least 26 weight percent, or at least 29 weight percent of the dry amino acid mixture.

In some embodiments, the mixture of amino acids includes arginine. Arginine can be included in the mixture of amino acids in an amount of at least 10 weight percent of the dry amino acid mixture. For example, arginine can be included in the mixture of amino acids in an amount of at least 11 weight percent, at least 14 weight percent, or at least 17 weight percent of the dry amino acid mixture.

In some embodiments, the mixture of amino acids includes proline. Proline can be included in the mixture of amino acids in an amount of at least five weight percent of the dry amino acid mixture. For example, proline can be included in the mixture of amino acids in an amount of at least seven weight percent or at least ten weight percent of the dry amino acid mixture.

In some embodiments, the mixture of amino acids includes aspartic acid. Aspartic acid can be included in the mixture of amino acids in an amount of at least five weight percent of the dry amino acid mixture. For example, aspartic acid can be included in the mixture of amino acids in an amount of at least six weight percent or at least eight weight percent of the dry amino acid mixture.

In some embodiments, the mixture of amino acids further includes one or more additional amino acids selected from threonine, serine, glycine, alanine, valine, methionine, isoleucine, tyrosine, phenylalanine, lysine, histidine, cysteine, or cystine. The one or more additional amino acids can each be included in an amount of five weight percent or less based on the weight of the dry amino acid mixture. For example, threonine, serine, glycine, alanine, valine, methionine, isoleucine, leucine, tyrosine, phenylalanine, lysine, histidine, cysteine, and/or cystine can each individually be included in the dry amino acid mixture in an amount of five weight percent or less, four weight percent or less, three weight percent or less, two weight percent or less, one weight percent or less, or 0.5 weight percent or less.

In one non-limiting embodiment, a sizing composition of the present invention comprises a mixture of amino acids that includes glutamic acid, arginine, proline, aspartic acid, and one or more additional amino acids. In this embodiment, the amount of glutamic acid can be at least 20 weight percent of the dry amino acid mixture, the amount of arginine can be at least 10 weight percent of the dry amino acid mixture, the amount of proline can be at least 5 weight percent of the dry amino acid mixture, the amount of aspartic acid can be at least 5 weight percent of the dry amino acid mixture, and the amount of each of the additional amino acids can be 5 weight percent or less of the dry amino acid mixture. In a further embodiment, the amount of glutamic acid can be at least 23 weight percent of the dry amino acid mixture, the amount of arginine can be at least 14 weight percent of the dry amino acid mixture, the amount of proline can be at least 7 weight percent of the dry amino acid mixture, the amount of aspartic acid can be at least 6 weight percent of the dry amino acid mixture, and the amount of each of the additional amino acids can be 5 weight percent or less of the dry amino acid mixture. In a further embodiment, the amount of glutamic acid can be at least 29 weight percent of the dry amino acid mixture, the amount of arginine can be at least 17 weight percent of the dry amino acid mixture, the amount of proline can be at least 10 weight percent of the dry amino acid mixture, the amount of aspartic acid can be at least 8 weight percent of the dry amino acid mixture, and the amount of each of the additional amino acids can be 5 weight percent or less of the dry amino acid mixture.

In some non-limiting embodiments, the mixture of amino acids is derived from a corn protein, a wheat protein, and a soy protein. Optionally, the mixture of amino acids is derived from a hydrolyzed corn protein, a hydrolyzed wheat protein, and a hydrolyzed soy protein. One example of a mixture of amino acids suitable for use in some embodiments of sizing compositions of the present invention is PHYTOKERATIN PF, which is a mixture of amino acids derived from hydrolyzed corn protein, hydrolyzed wheat protein, and hydrolyzed soy protein commercially available from Lonza (Basel, Switzerland).

Further examples of commercially available mixtures of amino acids that can be used in some embodiments of the present invention include COLLAMINO 25, which is a mixture of collagen amino acids from Lonza; KERAMINO 25, which is a mixture of keratin amino acids from Lonza; MILKAMINO 20 PF, which is a mixture of milk amino acids from Lonza; OLEO PHYTOKERATIN SH, which is a mixture of amino acids derived from AMP-isostearyl wheat protein, corn protein, and soy protein from Lonza; QUAT PHYTOKERATIN PF, which is a mixture of amino acids derived from hydroxypropyltrimonium corn protein, wheat protein, and soy protein from Lonza; WHEAT AMINO 30 PF, which is a mixture of wheat amino acids from Lonza; and SOLU-SILK SF, which is a mixture of silk amino acids from Lonza.

In embodiments of sizing compositions that comprise an amino acid, the amino acid is generally present in the sizing composition in an amount of at least about 0.001 weight percent, the percentages based on the total solids of the sizing composition. Optionally, the amino acid is present in the sizing composition in an amount of at least about 0.1 weight percent, at least about 0.3 weight percent, at least about 0.5 weight percent, at least about 1 weight percent, at least about 5 weight percent, at least about 10 weight percent, at least about 15 weight percent, at least about 20 weight percent, at least about 25 weight percent, at least about 30 weight percent, at least about 35 weight percent, at least about 40 weight percent, at least about 45 weight percent, at least about 50 weight percent, at least about 55 weight percent, at least about 60 weight percent, at least about 65 weight percent, at least about 70 weight percent, at least about 75 weight percent, at least about 80 weight percent, at least about 85 weight percent, at least about 90 weight percent, at least about 95 weight percent, or at least about 99 weight percent in other embodiments. The amino acid is present in the sizing composition in an amount of up to about 99 weight percent, the percentages based on the total solids of the sizing composition, in some embodiments.

In some non-limiting embodiments, a sizing composition of the present invention comprises a protein. In some embodiments, the protein is derived from a synthetic source. In other embodiments, the protein is derived from a natural source. For example, the protein can be a plant-based protein. Examples of suitable plant-based proteins include amaranth, soy protein, wheat protein, corn protein, rice protein, vegetable protein, and mixtures thereof. In some embodiments, the protein includes an animal-based protein. Examples of suitable animal-based proteins include collagen, keratin, elastin, and mixtures thereof. In other embodiments, the protein includes a marine-based protein. Examples of suitable marine-based proteins include collagen, elastin, and mixtures thereof. In still other embodiments, the protein can include a milk protein or a silk protein. In one non-limiting embodiment, the protein includes a corn protein, a wheat protein, and a soy protein.

In some embodiments, the protein can include proteins derived from a combination of sources. For example, the sizing composition of the present invention can comprise one or more synthetic proteins and/or one or more natural proteins. In some embodiments, the sizing composition of the present invention can include one or more plant-based proteins, one or more animal-based proteins, one or more marine-based proteins, milk protein, and/or silk protein.

Examples of commercially available proteins that can be used in some embodiments of the present invention include SOLU-COLL and SOLU-MAR NATIVE, which are soluble collagen proteins from Lonza; MARINE PLASMA EXTRACT, which is a soluble collagen-containing extract from Lonza; SOLU-COLL M, which is a soluble marine collagen from Lonza; and FIBRO-SILK powder, which is a silk protein from Lonza.

The protein can be a modified protein, in some embodiments. For example, sizing composition of the present invention can comprise a hydrolyzed protein. In some embodiments, the hydrolyzed protein is derived from a synthetic source. In other embodiments, the hydrolyzed protein is derived from a natural source. For example, the hydrolyzed protein can be a hydrolyzed plant-based protein. Examples of suitable hydrolyzed plant-based proteins include hydrolyzed amaranth, hydrolyzed soy protein, hydrolyzed wheat protein, hydrolyzed corn protein, hydrolyzed rice protein, hydrolyzed vegetable protein, and mixtures thereof. In some embodiments, the protein includes a hydrolyzed animal-based protein. Examples of suitable hydrolyzed animal-based proteins include hydrolyzed collagen, hydrolyzed keratin, hydrolyzed elastin, and mixtures thereof. In other embodiments, the protein includes a hydrolyzed marine-based protein. Examples of suitable hydrolyzed marine-based proteins include hydrolyzed collagen, hydrolyzed elastin, and mixtures thereof. In one non-limiting embodiment, the hydrolyzed protein includes a hydrolyzed corn protein, a hydrolyzed wheat protein, and a hydrolyzed soy protein.

In some embodiments, the hydrolyzed protein can include hydrolyzed proteins derived from a combination of sources. For example, the sizing composition of the present invention can comprise one or more hydrolyzed proteins from a synthetic source and/or one or more hydrolyzed proteins from a natural source. In some embodiments, the sizing composition of the present invention can include one or more hydrolyzed plant-based proteins, one or more hydrolyzed animal-based proteins, and/or one or more hydrolyzed marine-based proteins.

Examples of commercially available hydrolyzed proteins that can be used in some embodiments of the present invention include HYDROCOLL EN-55 and HYDROLCOLL EN-SD, which are hydrolyzed collagen proteins from Lonza; HYDROKERATIN AL-30, which is a hydrolyzed keratin protein from Lonza; QUAT-KERATIN WKP, which is a cocodimonium hydroxypropyl hydrolyzed keratin protein from Lonza; SOLU-LASTIN 30, which is a hydrolyzed elastin from Lonza; AMARANTH S, which is a sodium cocoyl hydrolyzed amaranth protein from Lonza; FOAM-COLL 4C and FOAM-COLL 4CM, which are potassium cocoyl hydrolyzed collagen proteins from Lonza; FOAM-COLL 5, which is a triethylamine-cocoyl hydrolyzed collagen protein mixed with sorbitol from Lonza; FOAM-SOY C, which is a sodium cocoyl hydrolyzed soy protein from Lonza; FOAM-WHEAT C, which is a sodium cocoyl hydrolyzed wheat protein from Lonza; SOLU-MAR ELASTIN and SOLU-MAR ELASTIN SD, which are hydrolyzed elastin proteins from Lonza; HYDROMILK EN-20, which is a hydrolyzed milk protein from Lonza; AMARANTH PRO ECT, which is a hydrolyzed amaranth protein from Lonza; QUAT-WHEAT CDMA 30 PF, which is a cocodimonium hydroxypropyl hydrolyzed wheat protein from Lonza; RICE-PRO EN-20 PF, which is a hydrolyzed rice protein from Lonza; SOLU-SOY EN-25 PF, which is a hydrolyzed soy protein from Lonza; SOLU-VEG EN-35 PF, which is a hydrolyzed vegetable protein from Lonza; WHEAT-PRO EN-20 PF, which is a hydrolyzed wheat protein from Lonza; and SOLU-SILK PROTEIN and SOLU-SILK PROTEIN 20, which are hydrolyzed silk proteins from Lonza.

In embodiments comprising a protein and/or hydrolyzed protein, the protein and/or hydrolyzed protein is generally present in the sizing composition in an amount of at least about 0.001 weight percent, the percentages based on the total solids of the sizing composition. Optionally, the protein or hydrolyzed protein is present in the sizing composition in an amount of at least about 0.1 weight percent, at least about 0.3 weight percent, at least about 0.5 weight percent, at least about 1 weight percent, at least about 5 weight percent, at least about 10 weight percent, at least about 15 weight percent, at least about 20 weight percent, at least about 25 weight percent, at least about 30 weight percent, at least about 35 weight percent, at least about 40 weight percent, at least about 45 weight percent, at least about 50 weight percent, at least about 55 weight percent, at least about 60 weight percent, at least about 65 weight percent, at least about 70 weight percent, at least about 75 weight percent, at least about 80 weight percent, at least about 85 weight percent, at least about 90 weight percent, at least about 95 weight percent, or at least about 99 weight percent in other embodiments. The protein or hydrolyzed protein is present in the sizing composition in an amount of up to about 99 weight percent, the percentages based on the total solids of the sizing composition in some embodiments.

In some embodiments, the protein is hydrolyzed to form individual amino acids and/or peptide segments containing amino acids linked by amide bonds. For example, the protein can be hydrolyzed to form oligopeptides or polypeptides. Such oligopeptides or polypeptides are suitable for use in some embodiments of sizing compositions described herein. In some non-limiting embodiments, the protein is hydrolyzed to form a mixture of amino acids as described above.

In one aspect, embodiments of the present invention relate to sizing compositions that comprise one or more amino acids, one or more proteins, one or more hydrolyzed proteins, or combinations thereof. In addition to the amino acid(s), protein(s), and/or hydrolyzed protein(s), sizing compositions of the present invention can further comprise any number of other components typically used in sizing compositions. Such other components can include, without limitation, film-formers, coupling agents (e.g., silanes), starches, oils, lubricants (cationic and/or non-ionic), one or more emulsifying agents or surfactants, cross-linkers, viscosity modifiers, plasticizers, antioxidants, pH adjusters, diluents, anti-foaming agents, anti-static agents, biocides, and other ingredients known to those of skill in the art to be useful in sizing compositions.

In formulating a sizing composition of the present invention that incorporates one or more amino acids, one or more proteins, and/or one or more hydrolyzed proteins, one approach is to incorporate such ingredients into an existing sizing composition making adjustments as necessary based on inclusion of the amino acid(s), protein(s), and/or hydrolyzed protein(s).

Sizing compositions of the present invention can be prepared using techniques known to those of skill in the art and applied to the glass fibers using techniques known in the art.

While certain components of sizing compositions of some embodiments of the present invention are discussed further herein, it should be understood that other components can also be used and/or combined in accordance with other embodiments. Embodiments of sizing compositions of the present invention can further comprise at least one film-former. A number of film formers can used in various embodiments of the present invention. In general, sizing compositions of the present invention can comprise any film former known to those of skill in the art including various combinations thereof. Non-limiting examples of film formers that can be used in various embodiments of the present invention comprise epoxies, polyvinylpyrrolidones, polyesters, polyurethanes, or mixtures, or copolymers, or aqueous dispersions thereof.

In some embodiments, the at least one film-former comprises an epoxy polymer. One non-limiting example of an epoxy polymer that can be used in some embodiments is EPI-REZ 3514-W56, from Momentive Specialty Chemicals Inc., which is an aqueous dispersion of an epoxy resin having an epoxy equivalent weight of 205-225 g/eq. Another non-limiting example of an epoxy polymer that can be used in some embodiments is EPON 828, from Momentive Specialty Chemicals Inc., which is an epoxy resin having an epoxy equivalent weight of 185-192g/eq. Other non-limiting examples of epoxy polymers that can be used include, without limitation, EPI-REZ 3540-WY-55 from Momentive Specialty Chemicals Inc., which is an aqueous dispersion of a bisphenol A epoxy resin with an equivalent weight of 1850 g/eq, EPI-REZ 5054-W-65 from Momentive Specialty Chemicals Inc., which is an aqueous dispersion of a bisphenol A epoxy resin with an equivalent weight of 192 g/eq, EPI-REZ 3515-W-60 from Momentive Specialty Chemicals Inc., which is an aqueous dispersion of a bisphenol A epoxy resin with an equivalent weight of 220-260 g/eq, and EPI-REZ 3522-W-60 from Momentive Specialty Chemicals Inc., which is an aqueous dispersion of a solid bisphenol A epoxy resin 550-650 g/eq. Depending on how an epoxy film-former is provided, one or more surfactants or emulsifying agents may need to be added to an epoxy emulsion in order to stabilize it in preparing a sizing composition. Other epoxy film-formers are provided as emulsions with one or more surfactants already included. Persons of ordinary skill in the art can determine whether one or more surfactants or emulsifying agents may need to be added to an epoxy emulsion based on the particular emulsion used.

Another example of a film-former that can be used in some embodiments of the present invention is polyvinylpyrrolidone. One non-limiting example of a polyvinylpyrrolidone that can be used in some embodiments of the present invention is polyvinylpyrrolidone K-30, which is commercially available from a variety of suppliers. Other non-limiting examples of polyvinylpyrrolidone that can be used include, without limitation, polyvinylpyrrolidone K-15 and polyvinylpyrrolidone K-90, which are commercially available from a variety of suppliers.

In some embodiments, the at least one film-former comprises starch. In some such embodiments, the starch component can be used along with the amino acid, protein, or hydrolyzed protein to provide a film forming character and to bind the glass fibers together into a strand in order that the strand will have enough integrity to withstand subsequent processing steps. In general, any starch known to those of skill in the art as being useful in sizing compositions can be used. In general, the starch film-former can be any water soluble starch such as dextrin, and/or any water insoluble starch, such as amylose. Exemplary starches that can be used in various embodiments of the present invention include commercially available starches such as those derived from corn, potato, wheat, sago, tapioca and arrow root that can be modified by crosslinking. Examples of starches that can be used in embodiments of the present invention include those having a low amylose content, which means that the starch composition can contain up to about 40 weight percent amylose in the starch in some embodiments, and between about 10 and about 30 weight percent in other embodiments. Starches useful in some embodiments of the present invention can utilize a mixture of modified potato and crosslinked corn starches both with a low amylose content. An example of a starch useful in embodiments of the present invention is CATO 75 cationic starch from National Starch and Chemical Co. Other examples of starches useful in embodiments of the invention can include, without limitation, Amaizo 213 starch manufactured by the American Maize Products Company and National 1554 manufactured by National Starch Company. Another example of a suitable starch is a low amylose starch that is water soluble after cooking such as a potato starch ether that is nonionic like that available from Avebe b.a. 9607 PT Foxhol, The Netherlands under the trade designation “Kollotex 1250.”

Additional types of starches that can be used are given in K. Loewenstein, The Manufacturing Technology of Glass Fibres, (3d Ed. 1993) at pages 238-41, which is hereby incorporated by reference. Other suitable starches include those described in U.S. Pat. Nos. 3,227,192; 3,265,516 and 4,002,445, each of which are hereby incorporated by reference.

As indicated above, sizing compositions according to various embodiments of the present invention can include one film-former or combinations of film-formers and should not be understood to be limited to only those specifically identified herein.

In some embodiments, the one or more film-formers are generally present in the sizing composition in an amount of about 50 percent or more by weight of the sizing composition on a total solids basis. The one or more film-formers, in some embodiments, can be present in the sizing composition, in an amount of about 90 percent or less by weight of the sizing composition on a total solids basis. The one or more film-formers, in some embodiments, can be present in the sizing composition, in an amount of about 60 percent or more by weight of the sizing composition on a total solids basis. In some embodiments, the one or more film-formers can be present in the sizing composition, in an amount of about 70 percent or more by weight of the sizing composition on a total solids basis. The one or more film-formers, in some embodiments, can be present in the sizing composition in an amount between about 60 percent and about 90 percent by weight of the sizing composition on a total solids basis.

In embodiments including starch as a film-former, the amount of starch utilized in some non-limiting embodiments of the present invention can be an effective film-forming amount of starch. In some non-limiting embodiments, the amount of starch can comprise up to 50 weight percent of the sizing composition based on total solids. In other non-limiting embodiments, the amount of starch can comprise up to 45 weight percent of the sizing composition based on total solids. In other non-limiting embodiments, the amount of starch can comprise greater than 30 weight percent of the sizing composition based on total solids. In some non-limiting embodiments, including embodiments for at least partially coating fiber glass strands for use in cement board applications, the amount of starch can comprise more than 38 weight percent of the sizing composition based on total solids. The sizing composition, in non-limiting embodiments, can comprise up to 42 weight percent starch based on total solids.

Some embodiments of sizing compositions of the present invention that comprise starch can further comprise at least one non-starch film former. The presence of a non-starch film former can assist the starch in providing an effective amount of film former by its ability to tack bond the filaments or fibers together at various contact points along the fibers. Such non-starch film-formers can include, without limitation, the polyvinyl pyrrolidone (“PVP”) homopolymers and copolymers of PVP, polyvinyl acetate, and polyvinyl alcohol, epoxy resins, polyesters and the like. Examples of suitable polyvinyl pyrrolidones include, without limitation, PVP K-15, PVP K-30, PVP K-60 and PVP K-90, each of which are commercially available from ISP Chemicals of Wayne, N.J. An alternative to PVP can be low molecular weight polyvinyl acetates since they can also provide a softer film on the surface of the glass fiber bundles.

Generally, the non-starch film former is present in effective amounts along with the starch to provide an effective cover for the fiber glass strand and to provide effective strand integrity, such that the integrity can be maintained when the strand is dried and subsequently processed. The non-starch film former, in embodiments of the present invention, can be present in an amount less than the amount of starch present in the sizing composition. In non-limiting embodiments, the amount of non-starch film former can comprise up to ten weight percent of the sizing composition based on total solids. In other non-limiting embodiments, the amount of non-starch film former can comprise up to eight weight percent of the sizing composition based on total solids. In other non-limiting embodiments, the amount of non-starch film former can comprise greater than one weight percent of the sizing composition based on total solids.

Sizing compositions of the present invention further comprise one or more coupling agents. In general, sizing compositions of the present invention can comprise any coupling agent known to those of skill in the art including various combinations thereof. Non-limiting examples of coupling agents that can be used in various embodiments of the present invention comprise silanes containing at least one acryl, alkyl, amino, chloro-alkyl, epoxy, mercapto, sulfide, perfluoro, phenyl, or vinyl group; zirconates (e.g., zirconium methacrylate); and titanates (e.g., alkyl titanates and tetrabenzyl titanate), among others.

In some embodiments, the coupling agents can comprise at least one amine and at least one aryl or arylene group. The coupling agent can comprise a silane in some embodiments of the present invention. Coupling agents typically have multiple functions. In embodiments where the coupling agent comprises an organo-silane, at least one of the silicon atoms has attached to it one or more groups which can react with the glass fiber surface or otherwise be chemically attracted, but not necessarily bonded, to the glass fiber surface. In embodiments where the glass fibers are to be at least partially coated with a secondary coating composition, the coupling agent may also interact with the secondary coating composition or a component of the secondary coating composition, such that the coupling agent facilitates adhesion between the glass fibers and the secondary coating compositions. Coupling agents can also be used to interact with a resin or resins that may be used in an end product, such that the coupling agent can facilitate adhesion between the glass fibers and the resin or resins.

In some embodiments of the present invention, a silane used as a coupling agent can comprise at least one primary or secondary amine and at least one aryl group or arylene group. The silane, in some embodiments, can further comprise additional primary amines, additional secondary amines, and/or tertiary amines. In some embodiments, the silane can comprise two or more secondary amines.

As used herein, “aryl group” refers to a group derived from an arene by removal of a hydrogen atom from a ring carbon atom. As used herein, “arylene group” refers to a bivalent group derived from an arene by removal of a hydrogen atom from two ring carbon atoms. As used herein, “arene” refers to a monocyclic or polycyclic aromatic hydrocarbon. Examples of arenes can include, without limitation, benzene and naphthalene. Examples of aryl groups can include without limitation, benzyl groups and phenyl groups. Examples of arylene groups can include, without limitation, vinyl benzyl groups.

Examples of silanes comprising at least one amine and at least one aryl group can comprise, without limitation, silanes comprising benzylamines and silanes comprising phenylamines. Silanes comprising benzylamines can comprise, in some embodiments, a silane comprising a benzylamino group. An example of a commercially available silane comprising a benzylamino group is DYNASYLAN® 1161 N-benzyl-N-aminoethyl-3-aminopropyltrimethoxysilane from Degussa AG of Dusseldorf, Germany, which has the following structure:

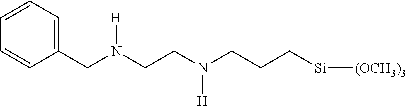

DYNASYLAN® 1161 comprises two secondary amines. Silanes comprising phenylamines can comprise, in some embodiments, a silane comprising a phenylamino group. An example of a commercially available silane comprising a phenylamino group is commercially available from GE Advanced Materials of Tarrytown, N.Y. as SILQUEST® Y-9669, which is N-phenyl-3-aminopropyltrimethoxysilane having the following structure:

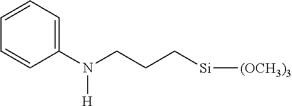

SILQUEST® Y-9669 comprises one secondary amine.

Another example of a commercially available silane useful in embodiments of the present invention is commercially available from GE Advanced Materials of Tarrytown, N.Y. as SILQUEST® A-1128. While the complete structure of SILQUEST® A-1128 is not publicly available, SILQUEST® A-1128 is understood to comprise a benzyl group and one or more amines.

Examples of silanes comprising at least one amine and at least one arylene group can include, without limitation, silanes comprising vinylbenzylamines. A silane comprising a vinylbenzylamine can comprise a silane comprising a vinylbenzylamino group. An example of a commercially available silane comprising a vinylbenzylamino group is DYNASYLAN® 1172 N-2-(vinylbenzylamino)-ethyl-3-aminopropyltrimethoxysilane from Degussa AG of Dusseldorf, Germany, which has the following structure:

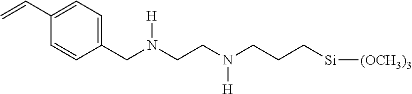

Another example of a commercially available silane comprising a vinylbenzylamino group is DYNASYLAN® 1175 from Degussa AG of Dusseldorf, Germany, which is believed to have the same structure as DYNASYLAN® 1172. Another example of a commercially available silane comprising a vinylbenzylamino group is Z-6032 N-2-(vinylbenzylamino)-ethyl-3-aminopropyltrimethoxysilane from Dow Corning. DYNASYLAN 1172 is provided in acetic acid while DYNASYLAN 1175 and Z-6032 are provided in hydrochloric acid. Another example of a commercially available silane comprising a vinylbenzylamino group is KBM-974, which is a [3-[[2-[(vinylbenzyl)amino]ethyl]amino]propyl]trimethoxysilane commercially available from Shin-Etsu Chemical Co., Ltd. of Tokyo, Japan.

In embodiments of the present invention, a silane comprising at least one amine and at least one aryl or arylene group can have terminal unsaturation. As used herein, “terminal unsaturation” means that the silane includes at least one organo-functional group having a carbon-carbon double bond. An example of a silane having terminal unsaturation is a silane comprising a vinylbenzyl group.

Further examples of suitable silanes for use in the sizing compositions of the present invention include glycidoxypropyltrialkoxysilanes, methacryoxypropyltrialkoxysilanes, and aminofunctional silanes. Non-limiting examples of suitable silanes include SILQUEST A-174NT, which is a gamma-methacryloxypropyltrimethoxysilane from Momentive Performance Materials, Inc., A-187 gamma-glycidoxypropyltrimethoxysilane from OSi Specialties, DYNASYLAN® GLYMO 3-glycidyloxypropyltrimethoxysilane from Degussa AG of Dusseldorf, Germany, DYNASYLAN® MEMO 3-methacryloxypropyl-trimethoxysilane from Degussa, and aminofunctional silanes, such as A-1100 gamma-aminopropyltriethoxysilane, A-1120 N-(beta-aminoethyl)-gamma-aminopropyltrimethoxysilane, and other aminofunctional silanes in the A-1100 series from OSi Specialties or Momemntive Performance Materials, Inc., as well as DYNASYLAN® AMEO 3-aminopropyltriethoxysilane from Degussa AG of Dusseldorf, Germany. Other organo-silanes may also be used.

Non-limiting embodiments of sizing compositions of the present invention can also comprise a plurality of silanes. The multiple coupling agents can advantageously result in the sizing composition being compatible with a variety of resins, including thermosetting resins, thermoplastic resins, and other resins. The different functionalities on the silanes can result in the sizing composition being compatible with resins that are normally compatible with such functionalities. The amount and type of each silane used in a sizing composition of the present invention may be selected based on resin compatibility, effect on fiber glass strand properties (e.g., lower broken filaments, abrasion resistance, strand integrity, and strand friction), and compatibility with other components of the sizing composition. For example, aminofunctional silanes, and in particular gamma-aminopropyltriethoxysilanes, are believed to have a desirable effect on strand friction (e.g., reduce strand friction, which may be desirable for certain applications) when used in sizing compositions of the present invention.

In one non-limiting embodiment, a sizing composition of the present invention comprises at least two silanes: at least one methacryloxypropyltrialkoxysilane, such as SILQUEST A-174NT from Momentive Performance Materials, Inc. or DYNASYLAN® MEMO from Degussa AG; and at least one aminopropyltrialkoxysilane, such as SILQUEST A-1100 from Momentive Performance Materials, Inc. or DYNASYLAN® AMEO from Degussa AG.

As to the amount of the coupling agents in embodiments of sizing compositions of the present invention, one or more silanes comprise greater than 1 percent by weight of the sizing composition on a total solids basis in some embodiments. In some embodiments, one or more silanes in the sizing compositions comprise greater than 2.5 percent by weight on a total solids basis. In other embodiments, one or more silanes comprise greater than 5 weight percent of the sizing composition on a total solids basis.

The use of a coupling agent in amounts of 8 percent by weight or greater based on a total solids basis of the sizing composition can result in fiber glass strands having a tensile strength that is particularly suitable for some applications, such as reinforcing cement board. Thus, silanes can comprise greater than about 8 percent by weight of the sizing composition on a total solids basis in some embodiments. In some embodiments, silanes can comprise up to about 14 percent by weight of the sizing composition on a total solids basis. Silanes can comprise up to about 12 percent by weight of the sizing composition on a total solids basis in some embodiments. Silanes, in some embodiments, can comprise between about 5 and about 14 percent by weight of the sizing composition on a total solids basis. In some embodiments, silanes can comprise between about 8 and about 12 percent by weight of the sizing composition on a total solids basis.

Some embodiments of sizing compositions of the present invention can also comprise one or more nonionic lubricants. Nonionic lubricants useful in some embodiments of the present invention may advantageously reduce yarn friction, increase lubrication, protect against glass-to-contact point abrasion during manufacture and in downstream processing (e.g., at a customer of a fiber glass manufacturer), etc. For example, nonionic lubricants useful in some embodiments of the present invention may reduce fiber to metal friction during manufacture and processing. Nonionic lubricants useful in embodiments of the present invention can generally be selected using techniques known to those of skill in the art.

In some non-limiting embodiments, the nonionic lubricant can comprise one or more oils. In selecting an oil for use in non-limiting embodiments of the present invention, compatibility with the other components of the sizing composition is an important consideration. Examples of oils suitable for use in embodiments of the present invention can include, without limitation, triglyceride oils and partially hydrogenated oils based on palm, coconut, soybean, corn etc. An example of a commercially available soybean oil useful in embodiments of the present invention is CT 7000 soybean oil from C & T Refinery, Inc. of Charlotte, N.C. Palm oil useful in embodiments of the present invention is commercially available from C & T Refinery, Inc. of Charlotte, N.C. An example of a commercially available corn oil useful in embodiments of the present invention is Pureco Oil K22 from Abitec Corporation of Columbus, Ohio.

In some non-limiting embodiments, the amount of oil can comprise up to 40 weight percent of the sizing composition based on total solids. In other non-limiting embodiments, the amount of oil can comprise up to 20 weight percent of the sizing composition based on total solids. In non-limiting embodiments, the amount of oil can comprise up to 10 weight percent of the sizing composition based on total solids. In non-limiting embodiments, the amount of oil can comprise greater than 5 weight percent of the sizing composition based on total solids. The amount of oil, in non-limiting embodiments, can comprise greater than 3 weight percent of the sizing composition based on total solids.

In some non-limiting embodiments, the nonionic lubricant can comprise one or more waxes. Examples of waxes suitable for use in the present invention include polyethylene wax, paraffin wax, polypropylene wax, microcrystalline waxes, and oxidized derivatives of these waxes. An example of a paraffin wax suitable for use in embodiments of the present invention is PACEMAKER P30 commercially available from CITGO Petroleum Corporation. Other examples of paraffin waxes suitable for use in embodiments of the present invention include, without limitation, Elon PW paraffin wax from Elon Specialties of Concord, N.C.; IGI 1230A paraffin wax from The International Group, Inc. of Wayne, Pa.; and Michem Lube 723 paraffin was from Michelman, Inc. of Cincinnati, Ohio.

In some non-limiting embodiments, the amount of wax can comprise up to 30 weight percent of the sizing composition based on total solids. In other non-limiting embodiments, the amount of wax can comprise up to about 25 weight percent of the sizing composition based on total solids. In other non-limiting embodiments, the amount of wax can comprise greater than 10 weight percent of the sizing composition based on total solids. In some non-limiting embodiments, the amount of wax can comprise greater than 20 weight percent of the sizing composition based on total solids.

In some non-limiting embodiments, sizing compositions of the present invention can comprise two or more nonionic lubricants. The sizing composition can comprise an oil and a wax in some non-limiting embodiments. The use of both an oil and a wax can be useful in obtaining desirable strand lubrication and can act as a processing aid to reduce abrasion of the strand with contact points during manufacture.

The oils and waxes useful in such embodiments can include those described above. The amount of oil and wax used in embodiments of the present invention can depend on a number of factors including, without limitation, the amount needed to sufficiently reduce fiber to metal friction during manufacture and processing, compatibility with the other components of the sizing composition, the ease with which the oil and/or wax can be dispersed in an aqueous sizing composition, the costs of components, the applications in which the coated fiber glass strand may be used, and others. In some non-limiting embodiments of sizing compositions that include oil and wax, the amount of wax can comprise up to 30 weight percent of the sizing composition based on total solids, and the amount of oil can comprise up to 40 weight percent of the sizing composition based on total solids. In other non-limiting embodiments, the amount of wax can comprise up to 25 weight percent of the sizing composition based on total solids, and the amount of oil can comprise up to 20 weight percent of the sizing composition based on total solids. In other non-limiting embodiments, the amount of wax can comprise up to 25 weight percent of the sizing composition based on total solids, and the amount of oil can comprise up to 10 weight percent of the sizing composition based on total solids.

Some embodiments of sizing compositions of the present invention can also comprise one or more emulsifying agents. Emulsifying agents can assist in dispersing hydrophobic materials, such as oils and waxes, in water or an aqueous solution. Emulsifying agents can also assist in emulsifying or dispersing components of the sizing compositions, such as oil or wax when used as a nonionic lubricant. Non-limiting examples of suitable emulsifying agents can include polyoxyalkylene block copolymers, ethoxylated alkyl phenols, polyoxyethylene octylphenyl glycol ethers, ethylene oxide derivatives of sorbitol esters, polyoxyethylated vegetable oils, ethoxylated alkylphenols, and nonylphenol surfactants. Examples of commercially available emulsifying agents useful in embodiments of the present invention can include TMAZ 81, which is an ethylene oxide derivative of a sorbitol ester and which is commercially available from BASF Corp. of Parsippany, N.J.; ICONOL OP-10, which is an alkoxylated alkyl (specifically, a phenol ethylene oxide adduct of octylphenol) and which is commercially available from BASF Corp.; MACOL OP-10 ethoxylated alkylphenol from BASF Corp.; TRITON X-100 from Rohm and Haas; TWEEN 81 from Croda Uniqema of New Castle, Del.; Genapol UD 050 from Clariant Corporation of Mt. Holly, N.C.; and IGEPAL CA-630 from Rhone-Poulenc.

As indicated above, some embodiments of the present invention can utilize one or more emulsifying agents. Multiple emulsifying agents can be used in some embodiments to assist in providing a more stable emulsion. Multiple emulsifying agents can be used in amounts effective to disperse hydrophobic components, such as oil and wax, in water or an aqueous solution. In some non-limiting embodiments of sizing compositions that include one or more emulsifying agents, the total amount of emulsifying agents can comprise up to 10 weight percent of the sizing composition based on total solids. In other non-limiting embodiments, the total amount of emulsifying agents can comprise up to five weight percent of the sizing composition based on total solids. In other non-limiting embodiments, the total amount of emulsifying agents can comprise up to 4.5 weight percent of the sizing composition based on total solids.

Some embodiments of sizing compositions of the present invention can further comprise a cationic lubricant. Cationic lubricants can be used in embodiments of the present invention, for example, to assist with internal lubrication, such as by reducing filament-to-filament or glass-to-glass abrasion. In general, most cationic lubricants known to those of skill in the art can be used in embodiments of the present invention. Non-limiting examples of cationic lubricants suitable in the present invention include lubricants with amine groups, lubricants with alkyl imidazoline derivatives (such as can be formed by the reaction of fatty acids with polyalkylene polyamines), lubricants with ethoxylated amine oxides, and lubricants with ethoxylated fatty amides. A non-limiting example of a lubricant with an amine group is a modified polyethylene amine, e.g. EMERY 6717, which is a partially amidated polyethylene imine commercially available from Cognis Corporation of Cincinnati, Ohio. Another example of a cationic lubricant useful in embodiments of the present invention is ALUBRASPIN 261, which is an alkyl imidazoline derivative commercially available from BASF Corp. Another example of a cationic lubricant useful in embodiments of the present invention is ALUBRASPIN 226, which is a partially amidated polyethylene imine commercially available from BASF Corp. of Parsippany, N.J. Other examples of cationic lubricants useful in non-limiting embodiments of the present invention can include EMERY 6760, which is commercially available from Cognis Corporation; CATION X, which is commercially available from Rhone Poulenc of Princeton, N.J.; KATAX 6717L, which is commercially available from Pulcra Chemicals of Rock Hill, S.C.; and STANTEX S FT 507, which is also commercially available from Pulcra Chemicals.

In some embodiments of a sizing composition utilizing a cationic lubricant, the amount of cationic lubricant can comprise up to ten weight percent of the sizing composition based on total solids. In other non-limiting embodiments, the amount of cationic lubricant can comprise up to eight weight percent of the sizing composition based on total solids. In further non-limiting embodiments, the amount of cationic lubricant can comprise up to six weight percent of the sizing composition based on total solids. Cationic lubricant can be used in an amount to assist with internal lubrication of fiber glass strands. In non-limiting embodiments, cationic lubricant can comprise greater than one weight percent of the sizing composition on a total solids basis.

Some embodiments of the present invention can comprise a second cationic lubricant, which can also assist with internal lubrication. In addition to the lubricants listed above, another lubricant which can be present in non-limiting embodiments of the sizing composition is a polyamide resin. A non-limiting example of such a lubricant is VERSAMID 140 polyamide resin, which is commercially available from Cognis Corp. of Cincinnati, Ohio.

Using a cationic lubricant and a polyamide resin as a second cationic lubricant can be useful in at least partially coating fiber glass strands for certain applications, such as reinforcing cement board. In embodiments of the present invention that comprise a cationic lubricant and a polyamide resin, the polyamide resin can comprise up to ten weight percent of the sizing composition based on total solids. In non-limiting embodiments, the amount of polyamide resin can comprise up to eight weight percent of the sizing composition based on total solids. In non-limiting embodiments, the amount of polyamide resin can comprise greater than five weight percent of the sizing composition based on total solids.

In some embodiments, a polyamide resin, such as VERSAMID 140 resin, can be used as the only cationic lubricant in the sizing composition. The polyamide resin can be used in an amount sufficient to assist with internal lubrication in some embodiments. In some embodiments, the polyamide resin can comprise up to fifteen weight percent of the sizing composition based on total solids. In other non-limiting embodiments, the amount of polyamide resin can comprise between greater than six weight percent of the sizing composition based on total solids. In other non-limiting embodiments, the amount of polyamide resin can comprise greater than eight weight percent of the sizing composition based on total solids. The amount of polyamide resin, in non-limiting embodiments, can comprise up to 12 weight percent of the sizing composition based on total solids.

Some embodiments of sizing compositions of the present invention can comprise other components including, without limitation, anti-foaming agents, anti-static agents, biocides, and others. A biocide can be added as a precautionary measure to preclude potential problems associated with yeast, mold, aerobic bacteria, and other biological products. Any biocides known to those skilled in the art to control organic growth in sizing compositions for glass fibers can be used in sizing compositions of the present invention. Non-limiting examples of biocides that can be used in the present invention include organotin biocides, methylene thiocyanate biocides, and chlorinated compounds. An example of a methylene thiocyanite biocide is CL-2141 biocide, which is manufactured by Chem-Treat, Inc. Another example of a suitable methylene thiocyanite biocide is AMA-410W biocide available from Kemira. In some non-limiting embodiments, the amount of biocide can comprise up to five weight percent of the sizing composition based on total solids. In other non-limiting embodiments, the amount of biocide can comprise up to two weight percent of the sizing composition based on total solids.

Anti-foaming agents and anti-static agents can be used in non-limiting embodiments of the present invention to control foaming of the sizing composition and to reduce static in the fiber glass strands. Non-limiting examples of anti-foaming agents suitable for use in embodiments of the present invention include SAG 10, which is commercially available from Momentive Performance Materials, Inc., and MAZU DF-136 (also known as INDUSTROL DF-136) antifoaming agent, which is commercially available from BASF Corp. of Parsippany, N.J. Non-limiting examples of anti-static agents suitable for use in embodiments of the present invention include KATAX 6660 or KATAX 6661-A anti-static agents, which are commercially available from Cognis Corporation.

The present invention also relates to glass fibers at least partially coated with a sizing composition of the present invention and to various fiber glass products incorporating such glass fibers. The present invention also relates to methods of forming a plurality of glass fibers having sizing compositions of the present invention applied thereon. The present invention also relates to fiber glass strands comprising at least one glass fiber at least partially coated with an embodiment of a sizing composition of the present invention.

Persons of ordinary skill in the art will recognize that the present invention can be implemented in the production, assembly, and application of a number of glass fibers. Non-limiting examples of glass fibers suitable for use in the present invention can include those prepared from fiberizable glass compositions such as low dielectric constant glass, “E-glass”, “A-glass”, “C-glass”, “S-glass”, “ECR-glass” (corrosion resistant glass), and fluorine and/or boron-free derivatives thereof. Typical formulations of glass fibers are disclosed in K. Loewenstein, The Manufacturing Technology of Continuous Glass Fibres, (3d Ed. 1993). Persons of ordinary skill in the art can select the appropriate glass composition to use depending on the contemplated application.

Glass fibers of the present invention can be formed in any suitable method known in the art for forming glass fibers. For example, glass fibers can be formed in a direct-melt fiber forming operation or in an indirect, or marble-melt, fiber forming operation. In a direct-melt fiber forming operation, raw materials are combined, melted and homogenized in a glass melting furnace. The molten glass moves from the furnace to a forehearth and into fiber forming apparatuses where the molten glass is attenuated into continuous glass fibers. In a marble-melt glass forming operation, pieces or marbles of glass having the final desired glass composition are preformed and fed into a bushing where they are melted and attenuated into continuous glass fibers. If a premelter is used, the marbles are fed first into the premelter, melted, and then the melted glass is fed into a fiber forming apparatus where the glass is attenuated to form continuous fibers. In some embodiments of the present invention, the glass fibers can be formed by the direct-melt fiber forming operation. For additional information relating to glass compositions and methods of forming the glass fibers, see K. Loewenstein, The Manufacturing Technology of Continuous Glass Fibres, (3d Ed. 1993), at pages 30-44, 47-103, and 115-165, which are specifically incorporated by reference herein.

Immediately after formation, the filaments can be at least partially coated with an embodiment of a sizing composition of the present invention in some embodiments. The application of sizing compositions to glass fibers is well known in the art and can be accomplished by conventional methods such as a belt applicator, a “kiss-roll” applicator or by spraying. The glass fibers are then gathered into at least one strand, and collected into a forming package or roving on a winder. See generally K. Loewenstein, The Manufacturing Technology of Continuous Glass Fibres, (3d Ed. 1993).

The amount of sizing composition on fiber glass may be measured as “loss on ignition” or “LOI.” As used herein, the term “loss on ignition” or “LOI” means the weight percent of dried sizing composition present on the fiber glass as determined by Equation 1:

LOI=100×[(W_{dry}−W_{bare})/W_{dry}] (Eq. 1)

wherein W_{dry} is the weight of the fiber glass plus the weight of the coating after drying in an oven at 220° F. (about 104° C.) for 60 minutes, and W_{bare} is the weight of the bare fiber glass after heating the fiber glass in an oven at 1150° F. (about 621° C.) for 20 minutes and cooling to room temperature in a dessicator.

In general, although not limiting, the loss on ignition (LOI) of embodiments of fiber glass strands of the present invention may be up to 2.5 percent. In other non-limiting embodiments, the LOI can be up to 2 percent. In further non-limiting embodiments, the LOI can be up to 1.5 percent. At lower LOI levels, the broken filament levels of a fiber glass product can increase. However, increasing the LOI increases production costs. Thus, in non-limiting embodiments, the LOI can be between 0.5 and 1.5 weight percent.

Some embodiments of the present invention relate to fiber glass strands comprising glass fibers at least partially coated with a sizing composition of the present invention. Fiber glass strands can comprise glass fibers of various diameters, depending on the desired application. The diameter of the filaments used in non-limiting embodiments of fiber glass strands of the present invention can be between, in general, between 5 and 80 microns. In some non-limiting embodiments, the diameter of the filaments can be between 7 and 18 microns. In non-limiting embodiments, a fiber glass strand of the present invention can comprise between 20 and 10,000 filaments per strand. In other non-limiting embodiments, a fiber glass strand of the present invention can comprise between 200 and 4,500 filaments per strand. The strands, in non-limiting examples, can be from 50 yards per pound to more than 10,000 yards per pound depending on the application.

In some embodiments, fiber glass strands of the present invention can be formed into rovings. Rovings can comprise assembled, multi-end, or single-end direct draw rovings. Rovings comprising fiber glass strands of the present invention can comprise direct draw single-end rovings having various diameters, depending on the desired application.

Some embodiments of the present invention relate to yarns comprising a plurality of glass fibers at least partially coated with a sizing composition of the present invention. Yarns can have various twist levels and directions, depending on the desired application. In some embodiments, a yarn of the present invention has a twist in the z direction of about 0.5 to about 2 turns per inch. In other embodiments, a yarn of the present invention has a twist in the z direction of about 0.7 turns per inch.

Yarns can be made from one or more strands that are twisted together and/or plied, depending on the desired application. Yarns can be made from one or more strands that are twisted together but not plied; such yarns are known as “singles.” Yarns of the present invention can be made from one or more strands that are twisted together but not plied. In some embodiments, yarns of the present invention comprise 1-4 strands twisted together. In other embodiments, yarns of the present invention comprise 1 twisted strand.

Some embodiments of the present invention relate to fabrics comprising a plurality of glass fibers. In some embodiments, a fabric of the present invention comprises a plurality of woven yarns at least partially coated with a sizing composition of the present invention. Fabrics of the present invention, in some embodiments, can comprise at least one fill yarn comprising a plurality of glass fibers at least coated with a sizing composition of the present invention. Fabrics of the present invention, in some embodiments, can comprise at least one warp yarn comprising a plurality of glass fibers at least partially coated with a sizing composition of the present invention. In some embodiments, a fabric of the present invention comprises at least one fill yarn comprising a plurality of glass fibers at least partially coated with a sizing composition of the present invention and at least one warp yarn comprising a plurality of glass fibers at least partially coated with a sizing composition of the present invention.

Some embodiments of the present invention relate to composites comprising a polymeric resin and glass fibers at least partially coated with a sizing composition of the present invention. The glass fibers can be from a fiber glass strand according to some embodiments of the present invention. In some embodiments, the glass fibers in the composite can be in the form of a fabric incorporated into the composite. The glass fibers can be incorporated into the composite in other forms as well as known to those of skill in the art.

With regard to polymeric resins, composites of the present invention can comprise one or more of a variety of polymeric resins including both thermoplastic and thermosetting resins. In some embodiments, the polymeric resin comprises at least one of polyethylene, polypropylene, polyamide, polyimide, polybutylene terephthalate, polycarbonate, thermoplastic polyurethane, phenolic, polyester (e.g., unsaturated polyester), polyvinyl chloride, vinyl ester, polydicyclopentadiene, polyphenylene sulfide, polyether ether ketone, cyanate esters, bis-maleimides, and thermoset polyurethane resins. The polymeric resin can comprise an epoxy resin in some embodiments.

Composites of the present invention can be in a variety of forms and can be used in a variety of applications. Some examples of potential uses of composites according to some embodiments of the present invention include, without limitation, window applications (e.g., window profiles); braiding applications (e.g., electrical, thermal, and heat insulation); filament winding applications (e.g., piping and ducting); pultruded products (e.g., grafting, deck panels, sucker rods, ladder rails, and pultruded structural shapes); and various other applications, including, but not limited to, recreation applications, marine applications, decking, boats, and transportation. Persons of skill in the art can readily identify other composites and applications in which glass fibers in a variety of forms at least partially coated with sizing compositions of the present invention can be used.

Fiber glass strands at least partially coated with embodiments of sizing compositions of the present invention can be, for example, particularly compatible with polyvinyl chloride and other vinyl addition polymers. The fiber glass strands can be used in myriad forms in various ways with polymers like the vinyl addition polymers of polyvinyl chloride and plasticized polyvinyl chloride as in plastisol formulations. For example, fiber glass strands can be formed into woven or nonwoven mats for impregnation and/or encapsulation or coating by the polyvinyl chloride or plasticized polyvinyl chloride such as plastisols and organosols. The term “plastisol” is used in a manner consistent with its standard definition, that of a dispersion of a resin in a plasticizer. For example, a polyvinyl chloride plastisol is a uniform dispersion of a polyvinyl chloride resin in an appropriate plasticizer.

Woven and nonwoven mat formation can be accomplished by any method known to those skilled in the art. Traditionally, the woven mats or cloth are produced from twisted fiber glass strands. Embodiments of fiber glass strands of the present invention can be twisted on a twist frame using techniques known to those of skill in the art. The twisted strands are wound on bobbins. Twisted fiber glass strands can be woven into a fabric or laid down as scrim using techniques known to those of skill in the art. In some embodiments, a polymeric formulation can be applied to the individual strands prior to weaving or laying down as scrim, and in other embodiments, the polymeric formulation can be applied to the woven fabric or the scrim.

The impregnation, encapsulation, reinforcement and coating operations can be conducted by any method known to those skilled in the art with polymeric formulations like vinyl addition polymers and copolymers, such as polyvinyl chloride plastisols, known to those skilled in the art.

Embodiments of fiber glass strands of the present invention can be coated with a polyvinyl chloride plastisol and used to reinforce a cementitious material, such as cement board, using techniques known to those of ordinary skill in the art. Some embodiments of sizing compositions of the present invention can provide compatibility between the glass fibers and the polyvinyl chloride. Some embodiments of sizing compositions of the present invention can also provide improved tensile strength to the glass fibers, both prior to and after coating with polyvinyl chloride. Tensile strength of the fiber glass strands is important in the reinforcement of cementitious materials.

Coated fiber glass strands can be warped, woven, tenured, and placed in cement board using techniques known to those of skill in the art. Alkali resistance is an important property of the cement board, and cement boards manufactured utilizing embodiments of fiber glass strands of the present invention may demonstrate a desirable alkali resistance in some embodiments.

Embodiments of the present invention will now be illustrated in the following specific, non-limiting examples.

### EXAMPLES

Sizing compositions were prepared in accordance with the formulation of Example 1, as set forth in Table 1. This formulation provides ranges of components that can be included in some embodiments of sizing compositions of the present invention.

TABLE 1
Example 1

| | | % Effective | Weight % (Total |
|---|---|---|---|
| Component | Grams/10 Gal | Solids | Solids Basis) |
| Epoxy Resin¹ | 100-1300 | 60 | 6-78 |
| Amino Acid Mixture² | 1-1000 | 25 | 0.02-25 |
| Lubricant³ | 10-400 | 1000 | 1-40 |
| Polyester Resin⁴ | 0-1500 | 40 | 0-60 |
| Silane A⁵ | 0-200 | 60 | 0-12 |
| Silane B⁶ | 0-250 | 80 | 0-20 |
| Acetic Acid | 2 | 100 | 0.2 |
| Defoamer⁷ | 0.01-1 | 10 | 0.001-1 |

¹EPIREZ 3514, an epoxy resin from Momentive Performance Materials, Inc.
²PHYTOKERATIN PF, a 25% solids mixture of amino acids commercially available from Lonza.
³PEG 600 Monolaureate, a polyethylene glycol ester having an average molecular weight of 600.
⁴NEOXIL 966M, a resin system from DSM Coating Resins, Inc.
⁵An amino-containing silane, such as SILQUEST A-1100, a gamma-aminopropyl-triethoxysilane from Momentive Performance Materials, Inc.
⁶An acrylic-containing silane, such as SILQUEST A-174NT, a methacryloxy functional trimethoxysilane from Momentive Performance Materials, Inc.
⁷SAG 10, an anti-foaming agent from Momentive Performance Materials, Inc.

Additional formulations representing some embodiments of sizing compositions of the present invention are provided in Tables 2-4 as Examples 2-8.

Each of the sizing compositions in Tables 1-4 can be applied to glass fibers having a wide variety of diameters. For example, in some embodiments the glass fibers can be K fibers through Z fibers, which have fiber diameters from 7 microns to 35 microns. The sizing compositions can be applied using any technique known to those of skill in the art. The sizing compositions can be applied to any glass fibers having generally any composition known to those of skill in the art including, for example and without limitation, E-glass, S-glass, boron-free or low boron glass, and/or fluorine derivatives thereof. Fiber glass strands can be gathered and wound into packages on a winder and the packages were dried using conventional drying techniques as known to those skilled in the art. The fiber glass strands can also be gathered into a roving construction using methods known to those of skill in the art to form rovings having a variety of yields including, for example and without limitation, 56, 113, 206, 250, 413 and 450 yield.

Sizing compositions were prepared in accordance with the formulations set forth in Tables 1-4. In these Tables and the description following these Tables, formulation “Comparative Example 1” represents a comparative sizing composition while Examples 2-8 represent some embodiments of sizing compositions of the present invention. In Tables 2-4, the weight represents the weight of the identified component provided and the percentage in the parenthetical is the weight percent of that component on a total solids basis.

TABLE 2

| Component | Example 2 | Example 3 |
|---|---|---|
| Amino Acid | 359 g | 684 g |
| Mixture⁸ | (1.5%) | (3%) |
| Silane⁹ | 120 g | 118 |
| | (1.3%) | (1.3%) |
| Acetic Acid¹⁰ | 10 g | 9 g |
| Film Former A¹¹ | 5979 g | 5893 g |
| | (57.9%) | (57%) |
| Film Former B¹² | 2965 g | 2923 g |
| | (20.2%) | (20%) |
| Surfactant¹³ | 612 g | 603 g |
| | (10.6%) | (10.4%) |
| Lubricant¹⁴ | 980 g | 967 g |
| | (8.5%) | (8.4%) |
| Water | 7 gal | 7 gal |
| Anti-Foaming | 2 g | 2 g |
| Agent¹⁵ | (0.003%) | (0.003%) |
| Total Gallons | 10 gal | 10 gal |

⁸PHYTOKERATIN PF, a 25% solids mixture of amino acids commercially available from Lonza.
⁹SILQUEST A-1100, a gamma-aminopropyl-triethoxysilane from Momentive Performance Materials, Inc.
¹⁰Generic glacial acetic acid for adding with Silanes.
¹¹EPI-REZ 3514 W56, an epoxy resin from Momentive Performance Materials, Inc.
¹²NEOXIL 966M, a resin system from DSM Coating Resins, Inc.
¹³STANTEX S FT 507, a blend of esters and nonionic surfactants from Pulcra Chemicals.
¹⁴LUROL 14330, a textile spin finish lubricant from Goulston Technologies.
¹⁵SAG 10, an anti-foaming agent from Momentive Performance Materials, Inc.

TABLE 3

| Component | Example 4 | Example 5 |
|---|---|---|
| Amino Acid | 345 g | 696 g |
| Mixture¹⁶ | (1.5%) | (3%) |
| Silane¹⁷ | 121 g | 119 g |
| | (1.3%) | (1.3%) |
| Acetic Acid¹⁸ | 12 g | 12 g |
| Film Former¹⁹ | 7556 g | 7439 g |
| | (73.1%) | (72%) |
| Surfactant²⁰ | 774 g | 762 g |
| | (13.4%) | (13.2%) |
| Lubricant²¹ | 1239 g | 1220 g |
| | (10.7%) | (10.5%) |
| Water | 7 gal | 7 gal |
| Anti-Foaming Agent²² | 2 g | 2 g |
| | (0.003%) | (0.003%) |
| Total Gallons | 10 gal | 10 gal |

¹⁶PHYTOKERATIN PF, a 25% solids mixture of amino acids commercially available from Lonza.
¹⁷SILQUEST A-1100, a gamma-aminopropyl-triethoxysilane from Momentive Performance Materials, Inc.
¹⁸Generic glacial acetic acid for adding with Silanes.
¹⁹EPI-REZ 3514 W56, an epoxy resin from Momentive Performance Materials, Inc.
²⁰STANTEX S FT 507, a blend of esters and nonionic surfactants from Pulcra Chemicals.
²¹LUROL 14330, a textile spin finish lubricant from Goulston Technologies.
²²SAG 10, an anti-foaming agent from Momentive Performance Materials, Inc.

TABLE 4

| | Comparative | | | |
|---|---|---|---|---|
| Component | Example 1 | Example 6 | Example 7 | Example 8 |
| Amino Acid | — | 75 g | 224 g | 456 g |
| Mixture²³ | | (0.3%) | (0.7%) | (2%) |
| Silane A²⁴ | 702 g | 700 g | 628 g | 532 g |
| | (8.4%) | (8.4%) | (6.8%) | (7.6%) |
| Acetic Acid²⁵ | 29 g | 29 g | 116 g | 98 g |
| Silane B²⁶ | 125 g | 125 g | 112 g | 95 g |
| | (1.1%) | (1.1%) | (0.9%) | (1%) |
| Film Former A²⁷ | 4011 g | 4001 g | — | 3422 g |
| | (32.4%) | (32.3%) | | (33.1%) |
| Film Former B²⁸ | 2000 g | 2000 g | 2243 g | 1901 g |
| | (17%) | (17%) | (17.2%) | (19.4%) |
| Film Former C²⁹ | 2758 g | 2750 g | 2946 g | 2015 g |
| | (15.7%) | (15.6%) | (14.9%) | (13.8%) |
| Film Former D³⁰ | — | — | 5383 g | — |
| | | | (39%) | |
| Polyethylene | 642 g | 640 g | 574 g | 487 g |
| glycol ester³¹ | (9.2%) | (9.2%) | (7.4%) | (8.4%) |
| Cationic | 80 g | 80 g | 72 g | 61 g |
| lubricant³² | (1.2%) | (1.2%) | (0.9%) | (1.1%) |
| Surfactant³³ | 527 g | 525 g | 471 g | 399 g |
| | (7.6%) | (7.6%) | (6.1%) | (6.9%) |
| Lubricant³⁴ | 1028 g | 1025 g | 920 g | 779 g |
| | (7.4%) | (7.4%) | (6%) | (6.7%) |
| Water | 7.1 gal | 7.1 gal | 6 gal | 7 gal |
| Anti-Foaming | 2 g | 2 g | 2 g | 2 g |
| Agent³⁵ | 0.003% | 0.003% | (0.002%) | (0.003%) |
| Total Gallons | 10 gal | 10 gal | 10 gal | 10 gal |

²³PHYTOKERATIN PF, a 25% solids mixture of amino acids commercially available from Lonza.
²⁴SILQUEST A-174NT, a methacryloxy functional trimethoxysilane from Momentive Performance Materials, Inc
²⁵Generic glacial acetic acid for adding with Silanes.
²⁶SILQUEST A-1100, a gamma-aminopropyl-triethoxysilane from Momentive Performance Materials, Inc.
²⁷EPI-REZ 3514 W56, an epoxy resin from Momentive Performance Materials, Inc.
²⁸EPI-REZ 3522 W60, an epoxy resin from Momentive Performance Materials, Inc.
²⁹NEOXIL 966M, a resin system from DSM Coating Resins, Inc.
³⁰FRANKLIN K80, an aqueous dispersion of liquid bisphenol A epoxy resin from Franklin International.
³¹STANDAPOL 2661, a polyethylene glycol monolaurate having an average molecular weight of 600 from Henkel.
³²KATAX 6717L, a cationic lubricant from Pulcra Chemicals.
³³STANTEX S FT 507, a blend of esters and nonionic surfactants from Pulcra Chemicals.
³⁴LUROL 14330, a textile spin finish lubricant from Goulston Technologies.
³⁵SAG 10, an anti-foaming agent from Momentive Performance Materials, Inc.

### Preparation of Sizing Compositions

To prepare the sizing compositions shown as Examples 6-8 in Table 4, the specified amount of the lubricant was added to hot filtered and demineralized water in a mixing tank in warm water. The contents were held at a temperature of approximately 145° F. The Film Formers were added to the main mix tank, followed by the Amino Acid Mixture.

In a side mix tank, the specified amount of Acetic Acid was mixed with cold water (60-80° F.) and Silane A or B, e.g., the amino containing silane, was added slowly with slight agitation. The diluted Silane A or B was then added slowly to the main mix tank. Using the same procedure, the other of Silane A or B, e.g., the acrylic-containing silane, was also transferred to the main mix tank. The specified amount of Anti-Foaming Agent was then added to the main mix tank. The mixture was then diluted with demineralized water and mixed slowly for 10 minutes. The resulting size had a pH of approximately 3-6, with a solids percentage of 2-25%. The size was applied to fibers to give a Loss on Ignition (LOI) value of from 0.3-1.5%.

Sizing compositions falling within the ranges specified in Example 1 and sizing compositions according to Examples 2-5 can be prepared in a similar manner as detailed above.

### Preparation of Fiber Glass Strands

The sizing compositions of Examples 2-5 in Tables 2 and 3 were applied to E glass fibers having a T diameter of T250 using an applicator roll made into roving construction. After drying the packages using conventional techniques, the nominal LOI of the examples were measured to be 0.7%. Multiple packages of fiberglass roving at least partially coated with the compositions in the examples were collected for testing. The fiberglass roving product was a T250 product, meaning the filaments were nominal T filaments and a single roving weighed 250 yards per pound (1984 Tex). The nominal number of filaments in a roving of T250 is 2000.

The sizing compositions of Comparative Example 1 and Examples 6-8 in Table 4 were applied to E glass fibers having a Z diameter of Z56 using an applicator roll made into roving construction. After drying the packages using conventional techniques, the nominal LOI of the three examples were measured to be 0.7%. Multiple packages of fiberglass roving at least partially coated with the compositions in the comparative examples and examples were collected for testing. The fiberglass roving product was a Z56 product, meaning the filaments were nominal Z filaments and a single roving weighed 56 yards per pound (8856 Tex). The nominal number of filaments in a roving of Z56 is 4000.

### Measurement of Properties

### Examples 2-3

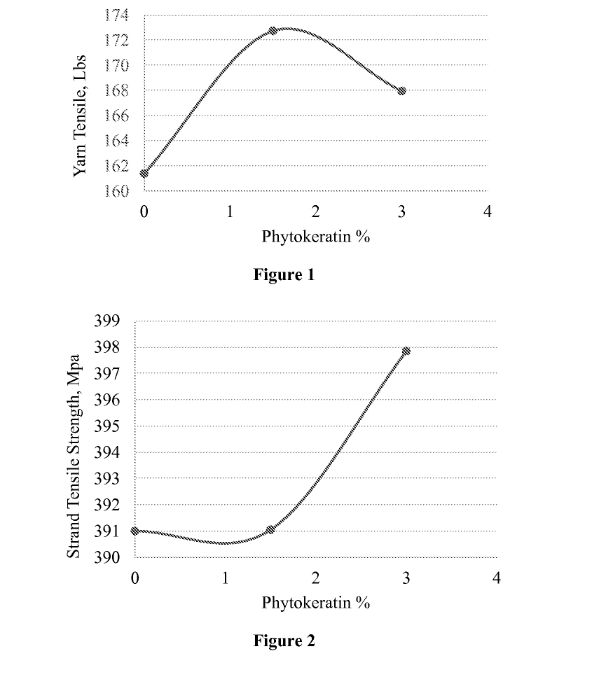

The dry roving tensile strengths of the sized fiber glass strands coated with Example 2 and Example 3 along with a control sizing composition (0% phytokeratin PF) were measured using ASTM D2256-10 (“Standard Test Method for Tensile Properties of Yarns by the Single-Strand Method”). FIG. 1 provide the results. As shown in FIG. 1, as low as 1.5% phytokeratin PF was effective in increasing the yarn tensile strength by 7%. In this particular formulation, higher usage of phytokerain did not further increase yarn tensile properties.

The strand tensile strengths of the sized fiber glass strands coated with Example 2 and Example 3 along with a control sizing composition (0% phytokeratin PF) were measured using ASTM D2343 (“Standard Test Method for Tensile Properties of Glass Fiber Strands, Yarns, and Rovings used in Reinforced Plastics”). FIG. 2 provide the results. As shown in FIG. 2, roving with 3 weight % of phytokeratin exhibited higher strand tensile properties.

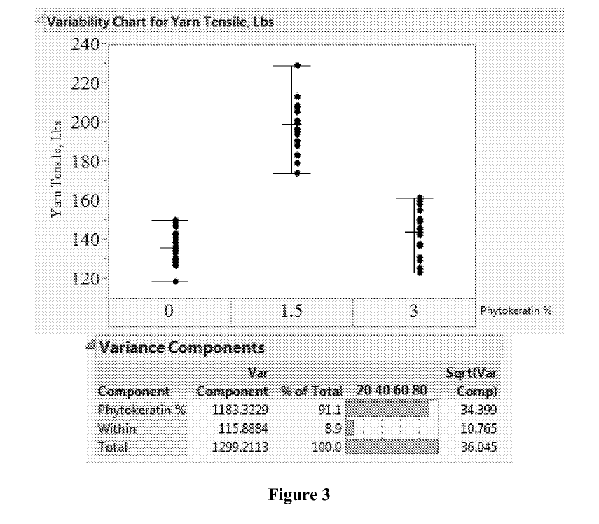

The dry roving tensile strengths of the sized fiber glass strands coated with Example 4 and Example 5 along with a control sizing composition (0% phytokeratin PF) were measured using ASTM D2256-10 (“Standard Test Method for Tensile Properties of Yarns by the Single-Strand Method”). FIG. 3 provide the results. As shown in FIG. 3, as low as 1.5% phytokeratin PF was effective in increasing the yarn tensile strength by 46%. In this particular formulation, high binder migration was noted at the 3% phytokeratin PF level, which could have contributed to the drop in yarn tensile at that level.

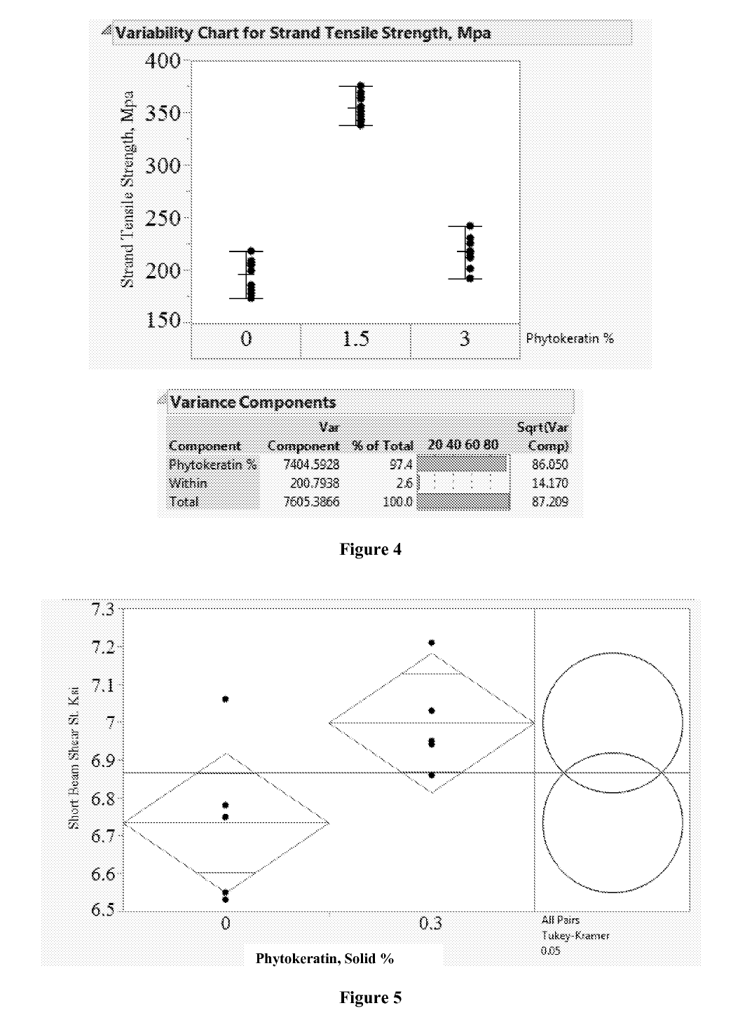

The strand tensile strength of the sized fiber glass strands coated with Example 4 and Example 5 along with a control sizing composition (0% phytokeratin PF) were measured using ASTM D2343 (“Standard Test Method for Tensile Properties of Glass Fiber Strands, Yarns, and Rovings used in Reinforced Plastics”). FIG. 4 provide the results. As shown in FIG. 4, rovings with a low 1.5 weight % of phytokeratin exhibited as high as 80% increase in strand tensile properties. In this particular formulation, high binder migration was noted at the 3% phytokeratin PF level, which could have contributed to the drop in strand tensile at that level.

### Comparative Example 1 and Example 6

Physical and mechanical properties of sized fiber glass strands coated with Comparative Example 1 and Example 6 were measured. The short beam shear strength, short beam shear modulus, and strand tensile strength were tested, as further detailed below.

Rods were prepared from the sized fiber glass strands coated with Comparative Example 1 and Example 6, and the short beam shear strength and short beam shear modulus were measured for each rod using ASTM D4475 (“Standard Test Method for Apparent Horizontal Shear Strength of Pultruded Reinforced Plastic Rods by the Short-Beam Method”). FIG. 5 and Table 5 provide the results for the short beam shear strength. As shown in FIG. 5 and Table 5, the shear strength increased with as low as 0.3 weight % of phytokeratin.

TABLE 5

| | | Mean | | | |
|---|---|---|---|---|---|
| | | Short | | | |
| | | Beam | | | |
| | | Shear | | | |
| | Number of | Strength | Standard | Lower | Upper |
| Example | Measurements | (ksi) | Error | 95% | 95% |
| Comparative | 5 | 6.73 | 0.080 | 6.55 | 6.92 |
| Example 1 | | | | | |
| (0% | | | | | |
| phytokeratin) | | | | | |
| Example 6 | 5 | 7.00 | 0.080 | 6.81 | 7.18 |
| (0.3% | | | | | |
| phytokeratin) | | | | | |

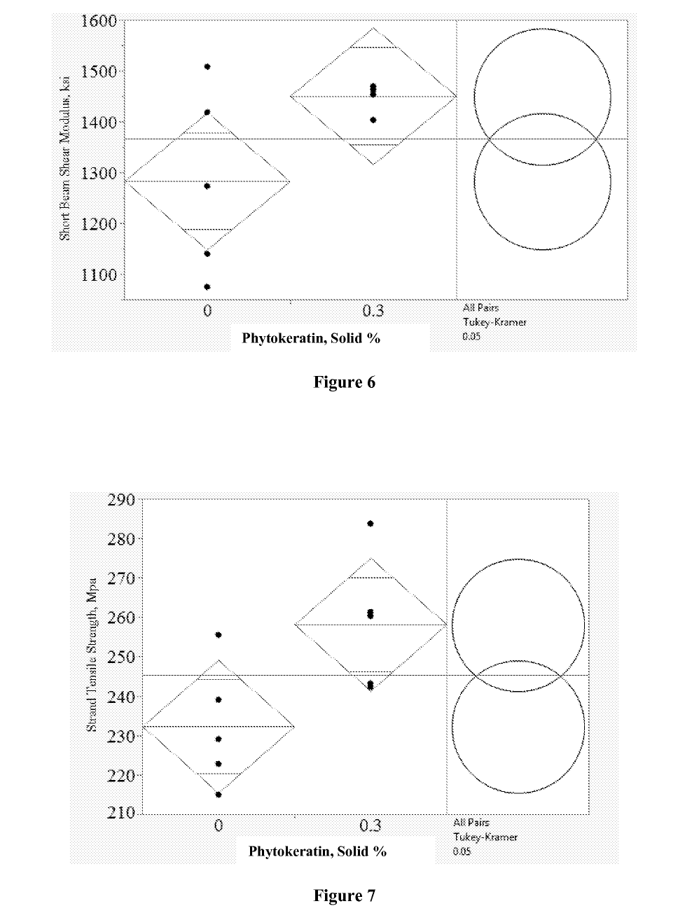

FIG. 6 and Table 6 provide the results for the short beam shear modulus. As shown in FIG. 6 and Table 6, the shear modulus increased with as low as 0.3 weight % of phytokeratin.

TABLE 6

| | | Mean | | | |
|---|---|---|---|---|---|
| | | Short | | | |
| | | Beam | | | |
| | | Shear | | | |
| | Number of | Modulus | Standard | Lower | Upper |
| Example | Measurements | (ksi) | Error | 95% | 95% |
| Comparative | 5 | 1283.20 | 58.3 | 1148.7 | 1417.7 |
| Example 1 | | | | | |
| (0% | | | | | |
| phytokeratin) | | | | | |
| Example 6 | 5 | 1450.80 | 58.3 | 1316.3 | 1585.3 |
| (0.3% | | | | | |
| phytokeratin) | | | | | |

The strand tensile strength of the sized fiber glass strands coated with Comparative Example 1 and Example 6 were measured using ASTM D2343 (“Standard Test Method for Tensile Properties of Glass Fiber Strands, Yarns, and Rovings used in Reinforced Plastics”). FIG. 7 and Table 7 provide the results. As shown in FIG. 7 and Table 7, rovings with as low as 0.3 weight % of phytokeratin exhibited higher strand tensile properties.

TABLE 7

| | | Mean | | | |
|---|---|---|---|---|---|
| | | Strand | | | |
| | | Tensile | | | |
| | Number of | Strength | Standard | Lower | Upper |
| Example | Measurements | (MPa) | Error | 95% | 95% |
| Comparative | 5 | 232.34 | 7.30 | 215.49 | 249.18 |
| Example 1 | | | | | |
| (0% | | | | | |
| phytokeratin) | | | | | |
| Example 6 | 5 | 258.19 | 7.30 | 241.35 | 275.04 |
| (0.3% | | | | | |
| phytokeratin) | | | | | |

### Example 7 and Example 8

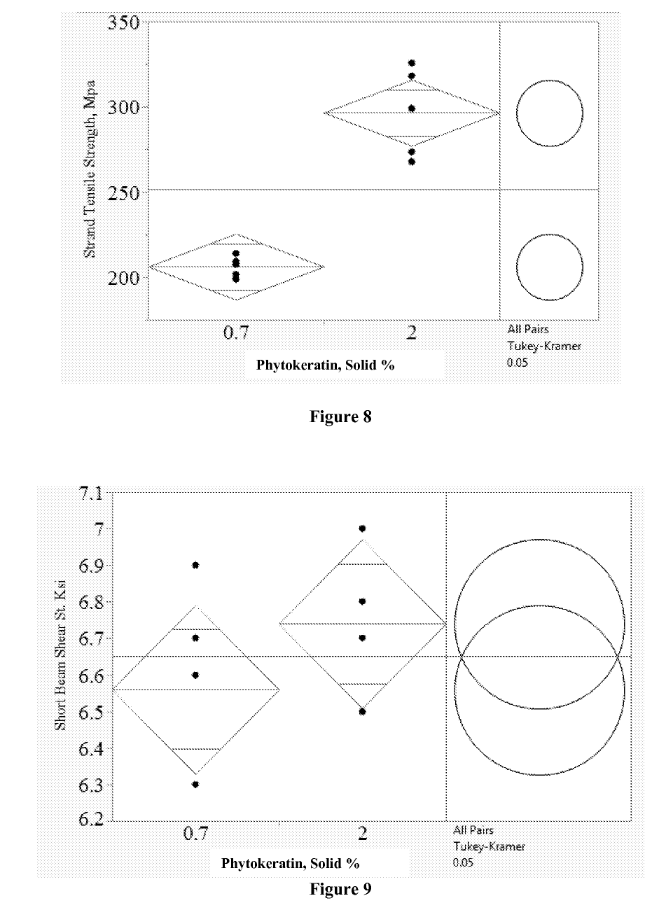

The dry roving tensile strengths of the sized fiber glass strands coated with Example 7 and Example 8 were measured using ASTM D2256-10 (“Standard Test Method for Tensile Properties of Yarns by the Single-Strand Method”). FIG. 8 and Table 8 provide the results.

TABLE 8

| | | Mean | | | |
|---|---|---|---|---|---|
| | | Strand | | | |
| | | Tensile | | | |
| | Number of | Strength | Standard | Lower | Upper |
| Example | Measurements | (MPa) | Error | 95% | 95% |
| Example 7 | 5 | 206.2 | 8.4 | 186.8 | 225.6 |
| (0.7% | | | | | |
| phytokeratin) | | | | | |
| Example 8 | 5 | 296.6 | 8.4 | 277.2 | 315.9 |
| (2% | | | | | |
| phytokeratin) | | | | | |

Rods were prepared from the sized fiber glass strands coated with Example 7 and Example 8, and the short beam shear strength was measured for each rod using the method described above. FIG. 9 and Table 9 provide the results.

TABLE 9

| | | Mean | | | |
|---|---|---|---|---|---|
| | | Short | | | |
| | | Beam | | | |
| | | Shear | | | |
| | Number of | Strength | Standard | Lower | Upper |
| Example | Measurements | (ksi) | Error | 95% | 95% |
| Example 7 | 5 | 6.56 | 0.10 | 6.33 | 6.79 |
| (0.7% | | | | | |
| phytokeratin) | | | | | |
| Example 8 | 5 | 6.74 | 0.10 | 6.51 | 6.97 |
| (2% | | | | | |
| phytokeratin) | | | | | |

Desirable characteristics, which can be exhibited by various embodiments of the present invention, can include, but are not limited to, the provision of sizing compositions that provide strengthening properties to glass fibers; the provision of fiber glass strands that can be processed with acceptable break levels during downstream processing; the provision of a sizing composition, that upon at least partially coating fiber glass strand, will result in the fiber glass strand exhibiting a desired tensile strength; the provision of fiber glass strands that can exhibit a desired tensile strength; the provision of a sizing composition, that upon at least partially coating fiber glass strand, will result in the sized fiber glass strand exhibiting a desired tensile strength; the provision of sized fiber glass strands that can be used to withstand rigorous processing conditions in applications like pultrusion, and to achieve increased composite properties in structural applications, such as composite beams where high strength, dimensional stability, and corrosion resistance are required; and others.

It is to be understood that the present description illustrates aspects of the invention relevant to a clear understanding of the invention. Certain aspects of the invention that would be apparent to those of ordinary skill in the art and that, therefore, would not facilitate a better understanding of the invention have not been presented in order to simplify the present description. Although the present invention has been described in connection with certain embodiments, the present invention is not limited to the particular embodiments disclosed, but is intended to cover modifications that are within the spirit and scope of the invention.

That which is claimed:

1. A sizing composition for glass fibers, comprising:
an amino acid, a protein, a hydrolyzed protein, or combinations thereof.

2. The sizing composition of claim 1, wherein the protein comprises a plant-based protein.

3. The sizing composition of claim 1, wherein the amino acid is derived from a plant-based protein.

4. The sizing composition of claim 1, wherein the hydrolyzed protein comprises a hydrolyzed plant-based protein.

5. The sizing composition of claim 2, wherein the plant-based protein comprises at least one of amaranth, soy protein, wheat protein, corn protein, rice protein, vegetable protein, and mixtures thereof.

6. The sizing composition of claim 1, wherein the protein comprises an animal-based protein.

7. The sizing composition of claim 1, wherein the amino acid is derived from an animal-based protein.

8. The sizing composition of claim 1, wherein the hydrolyzed protein comprises a hydrolyzed animal-based protein.

9. The sizing composition of claim 6, wherein the animal-based protein comprises at least one of collagen, keratin, elastin, and mixtures thereof.

10. The sizing composition of claim 1, wherein the protein comprises a marine-based protein.

11. The sizing composition of claim 1, wherein the amino acid is derived from a marine-based protein.

12. The sizing composition of claim 1, wherein the hydrolyzed protein comprises a hydrolyzed marine-based protein.

13. The sizing composition of claim 10, wherein the marine-based protein comprises at least one of collagen, elastin, and mixtures thereof.

14. The sizing composition of claim 1, wherein the protein comprises milk protein.

15. The sizing composition of claim 1, wherein the protein comprises silk protein.

16. The sizing composition of claim 1, wherein the protein is a modified protein.

17. The sizing composition of claim 1, wherein the protein comprises a corn protein, a wheat protein, and a soy protein.

18. The sizing composition of claim 1, wherein the hydrolyzed protein comprises a hydrolyzed corn protein, a hydrolyzed wheat protein, and a hydrolyzed soy protein.

19. The sizing composition of claim 1, wherein the amino acid comprises a mixture of amino acids.

20. The sizing composition of claim 19, wherein the mixture of amino acids is derived from a corn protein, a wheat protein, and a soy protein.

21. The sizing composition of claim 1, wherein the amino acid is derived from a synthetic source.

22. The sizing composition of claim 1, wherein the amino acid, the protein, or the hydrolyzed protein comprises at least about 0.001 weight percent of the sizing composition on a total solids basis.

23. The sizing composition of claim 1, wherein the amino acid, the protein, or the hydrolyzed protein comprises at least about 0.1 weight percent of the sizing composition on a total solids basis.

24. The sizing composition of claim 1, wherein the amino acid, the protein, or the hydrolyzed protein comprises at least about 0.3 weight percent of the sizing composition on a total solids basis.

25. The sizing composition of claim 1, further comprising at least one film-former.

26. The sizing composition of claim 25, wherein the at least one film-former comprises starch.

27. The sizing composition of claim 25, wherein the at least one film-former comprises an epoxy.

28. The sizing composition of claim 1, further comprising at least one silane.

29. The sizing composition of claim 1, further comprising at least one lubricant.

30. The sizing composition of claim 29, wherein the at least one lubricant comprises at least one non-ionic lubricant.

31. A sizing composition for glass fibers, comprising
an amino acid, a protein, or a hydrolyzed protein;
at least one film-former; and
at least one silane.

32. A glass fiber at least partially coated with the sizing composition of claim 1.

33. A fiber glass strand comprising at least one glass fiber at least partially coated with the sizing composition of claim 1.

34. A cement board comprising at least one fiber glass strand of claim 33.

35. A composite material comprising:
a polymeric resin; and
a plurality of glass fibers at least partially coated with the sizing composition of claim 1 disposed in the polymeric resin.

36. The composite material of claim 35, wherein the composite material comprises a pultruded product.
